(19) United States
(12) Patent Application Publication
(10) Pub. No.: US 2014/0085900 A1
(43) Pub. Date: Mar. 27, 2014

(54) Adjustable Framing Projector

(71) Applicant: Mountain Springs Holdings, LLC., Salt Lake City, UT (US)

(72) Inventor: Glenn Merlin Johnson, Salt Lake City, UT (US)

(73) Assignee: Mountain Springs Holdings, LLC., Salt Lake City, UT (US)

(21) Appl. No.: 14/037,338

(22) Filed: Sep. 25, 2013

Related U.S. Application Data
(60) Provisional application No. 61/705,519, filed on Sep. 25, 2012.

(51) Int. Cl. F21V 11/18

(52) U.S. Cl. CPC F21V 11/18
USPC 362/277; 362/321

(57) ABSTRACT

An adjustable light shaping apparatus is disclosed that includes a shaping housing that receives a beam of light from a luminaire and outlines a source shape through which the beam of light emanates to illuminate a target shape. The adjustable light shaping apparatus further includes two or more adjustable paddles movably coupled to the shaping housing, wherein each of the adjustable paddles is independently adjustable and each adjustable paddle has a framing edge. Further, the adjustable paddles may be oriented so that the framing edges intersect the beam of light and collectively illuminate an outline, defined in the present disclosure as a paddle-framed shape. The adjustable light shaping apparatus also includes an iris assembly connected to the shaping housing. The iris assembly includes an expandable and contractible iris that may intersect the beam of light to illuminate an outline, defined in the present disclosure as an iris-framed shape.

### CROSS-REFERENCES TO RELATED APPLICATIONS

This application claims the benefit of U.S. Provisional Patent Application No. 61/705,519 entitled “ADJUSTABLE FRAMING PROJECTOR” and filed on Sep. 25, 2012 for Glenn Merlin Johnson, which is incorporated herein by reference.

### FIELD

This disclosure relates to shaping a focused beam of light and more specifically providing multiple options for shaping a focused beam of light.

### BACKGROUND

Conventional light bulbs or light sources are radiant by nature. Light sources, such as incandescent bulbs, LEDs (Light Emitting Diodes), fluorescent lamps, halogen lamps, metal halide lamps, ceramic metal halide lamps, and mercury vapor lamps, are typically designed to produce spherical light that emanates outward in all directions. However, spherical light is not well-suited for certain applications. For example, spotlights, searchlights, automobile headlights, framing projectors, and video projectors, among others, often have a focusing or a reflecting mechanism that not only restricts a portion of the spherical light but also collects the light emanating in a wrong direction and reflects the light in a desired direction, thus intensifying the light energy emanating in the desired direction.

For example, parabolic reflectors have been conventionally implemented to provide directional light. By configuring a luminaire (i.e, a light fixture) to have the light source at the focus of a parabolic reflecting surface, commonly known as a paraboloid, the light waves that hit the paraboloid are reflected in a substantially collinear direction that is parallel to the axis of symmetry of the paraboloid. These collinear light waves, often referred to as collimated light, will not disperse with distance (or at least will disperse minimally). Therefore, luminaires that incorporate paraboloids are often used to produce a directional beam of light. However, even though a luminaire may produce a directional beam of light, certain applications require the beam of light to also have a specific shape.

For example, museums and art studios often implement framing projectors that can be configured to provide precise shape illumination. However, conventional framing projectors and other light shaping mechanisms often require extensive calibration in order to illuminate a target shape. For example, in order to illuminate a specific object that is a specific distance away from the luminaire and that is at a specific angled orientation with respect to the luminaire, users often must perform the necessary calculations and must manufacture a physical template to place in front of the beam of light to provide the proper light shaping. This process of measuring, calculating, and manufacturing the template is time consuming, complicated, expensive, not easily adaptable.

### SUMMARY

From the foregoing discussion, it should be apparent that a need exists for an apparatus, system, and method that allows for a beam of light to be quickly, easily, and adaptably shaped in order to illuminate a specific object. The subject matter of the present application has been developed in response to the present state of the art, and in particular, in response to the problems and needs in the art that have not yet been fully solved by currently available light shaping devices. Accordingly, the present disclosure has been developed to provide an apparatus, system, and method for shaping light that overcome many or all of the above-discussed shortcomings in the art.

The present disclosure relates to an adjustable light shaping apparatus that includes a shaping housing that receives a focused beam of light from a luminaire and outlines a source shape through which the focused beam of light emanates to illuminate a target shape. The source shape, as described below in greater detail, may be configured from a paddle-framed shape, an iris-framed shape, or a combination of the paddle-framed shape and the iris-framed shape. The adjustable light shaping apparatus further includes two or more adjustable paddles movably coupled to the shaping housing, wherein each of the adjustable paddles is independently adjustable and each adjustable paddle has a framing edge. Further, the adjustable paddles may be oriented so that the framing edges intersect the focused beam of light and collectively illuminate an outline, defined in the present disclosure as the paddle-framed shape. The adjustable light shaping apparatus also includes an iris assembly connected to the shaping housing. The iris assembly includes an expandable and contractible iris that may intersect the focused beam of light to illuminate an outline, defined in the present disclosure as the iris-framed shape.

In another embodiment, the adjustable light shaping apparatus may further include a slide groove in the shaping housing configured to receive a template pattern, wherein when the template pattern is inserted into the slide groove the template pattern intersects the focused beam of light to outline a template-framed shape. In this embodiment, the source shape may be configured from the paddle-framed shape, the iris-framed shape, the template-framed shape, or combination of one or more of the paddle-framed shape, the iris-framed shape, and the template-framed shape.

In another embodiment, the adjustable light shaping apparatus is configured to illuminate a rectangular target shape and the adjustable light shaping apparatus is positioned off center of the target shape. Therefore, the light shaping apparatus can be configured to produce a source shape that is a trapezoid. In another embodiment, the source shape is a polygonal-circular hybrid shape comprising portions of the paddle-framed shape and the iris-framed shape (i.e., using both the paddles and the iris to produce the source shape). Still further, the adjustable paddles of the apparatus may be rotatable and/or slidable in a plane that is substantially perpendicular to the longitudinal axis of the focused beam of light. Also, the adjustable paddles may each have an elongated slot that engages a securing assembly configured to hold the adjustable paddles in place with respect to the shaping housing. The securing assembly may include a bolt assembly or a cam assembly for securing the position of the adjustable paddles.

In another embodiment, the framing edges of the adjustable paddles may be substantially straight to outline a polygonal paddle-framed shape or the framing edges may be substantially curved to outline a rounded paddle-framed shape. The shaping housing may also include a shaping housing coupling that enables the shaping housing to be coupled to the luminaire. The shaping housing may also be adaptable to a plurality of shaping housing couplings and each shaping housing coupling may be configured for a specific luminaire. In another embodiment, the housing coupling is adaptable to two or more luminaires, wherein each of the two or more luminaires has a different interface for coupling. In yet another embodiment, the shaping housing is integral with the luminaire.

The adjustable light shaping apparatus include a framing projector and the framing projector may include a light condensing assembly. The light condensing assembly may have one or more lenses that condense light from the light source to the focused beam of light. In one embodiment, the luminaire is a theatrical spot light and the theatrical spot light is configured to produce the focused beam of light to transmit to the shaping housing.

The present disclosure also relates to a method for illuminating a target shape. The method includes coupling a shaping housing to a luminaire, the shaping housing receiving a focused beam of light from the luminaire. The shaping housing includes two or more adjustable paddles movably coupled to the shaping housing, wherein each of the adjustable paddles is independently adjustable and each adjustable paddle has a framing edge. The shaping housing also includes an iris assembly connected to the shaping housing, the iris assembly comprising an expandable and contractible iris. The next steps in the method includes directing the focused beam of light towards a target shape and then forming a beam of light to have a source shape that emerges from the shaping housing, wherein forming a source shape comprises adjusting one or more of the adjustable paddles so that the framing edges outline a paddle-framed shape, and the iris assembly to outline an iris-framed shape.

The method may further involve a shaping housing that has a slide groove for receiving a template pattern, the template pattern shaped to outline a template-framed shape. Therefore, forming a source shape includes one or more of the following: adjusting the adjustable paddles so that the framing edges outline a paddle-framed shape, adjusting the iris assembly to outline an iris-framed shape, and inserting a template pattern to outline a template-framed. Adjusting the paddles may include rotating the adjustable paddles in a plane that is substantially perpendicular to the longitudinal axis of the focused beam of light and/or sliding the adjustable paddles in a plane that is substantially perpendicular to the longitudinal axis of the focused beam of light. Still further, adjusting the paddles may include loosening a securing assembly in order to move adjustable paddles with respect to the shaping housing and subsequently re-tightening the securing assembly when the adjustable paddles are in a desired position.

The present disclosure also relates to an adjustable framing projector system. The system includes a light source mounted within a luminaire, wherein the light source within the luminaire generates a focused beam of light. The system further includes a light condensing assembly mounted within the luminaire or attached to the luminaire, wherein the light condensing assembly receives light from the light source and focuses the light to form the focused beam of light. Still further, the system includes a shaping housing that receives the focused beam of light from the light condensing assembly and shapes the focused beam of light to form a source shape through which the focused beam of light emanates to illuminate a target shape. The system may also include two or more adjustable paddles movably coupled to the shaping housing, wherein each of the adjustable paddles is independently adjustable and each adjustable paddle has a framing edge, wherein the adjustable paddles may be oriented so that the framing edges intersect the focused beam of light and collectively outline a paddle-framed shape. The system also includes an iris assembly connected to the shaping housing, the iris assembly comprising an expandable and contractible iris to intersect the focused beam of light to outline an iris-framed shape. The system further includes a slide groove in the shaping housing configured to receive a template pattern, wherein when the template pattern is inserted into the slide groove the template pattern intersects the focused beam of light to illuminate a template-framed shape. The source shape includes one or more of the following: the paddle-framed shape, the iris-framed shape, the template-framed shape, and a combination of one or more of the paddle-framed shape, the iris-framed shape, and the template-framed shape.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective exploded view of an adjustable light shaping apparatus receiving a focused beam of light from a luminaire, according to one embodiment;

FIG. 2 is a schematic block diagram of a an adjustable light shaping apparatus receiving a focused beam of light from a luminaire and illuminating a target shape, according to one embodiment;

FIG. 3 is a perspective exploded view of an adjustable light shaping apparatus, according to one embodiment;

FIG. 4 is a perspective exploded view of an adjustable light shaping apparatus, according to another embodiment;

FIG. 5 is a perspective exploded view of an adjustable light shaping system, including an adjustable light shaping apparatus, a light condensing assembly, and a luminaire, according to one embodiment;

FIG. 6A is a cross-sectional front view of an adjustable light shaping apparatus depicting a rectangular, paddle-framed source shape, according to one embodiment;

FIG. 6B is a cross-sectional front view of an adjustable light shaping apparatus depicting a trapezoidal, paddle-framed source shape, according to one embodiment;

FIG. 6C is a cross-sectional front view of an adjustable light shaping apparatus depicting a circular, iris-framed source shape, according to one embodiment;

FIG. 6D is a cross-sectional front view of an adjustable light shaping apparatus depicting a rectangular-circular hybrid source shape, according to one embodiment;

FIG. 6E is a cross-sectional front view of an adjustable light shaping apparatus depicting a template-framed source shape, according to one embodiment; and

FIG. 7 is a schematic flow chart diagram depicting a method for illuminating a target shape, according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

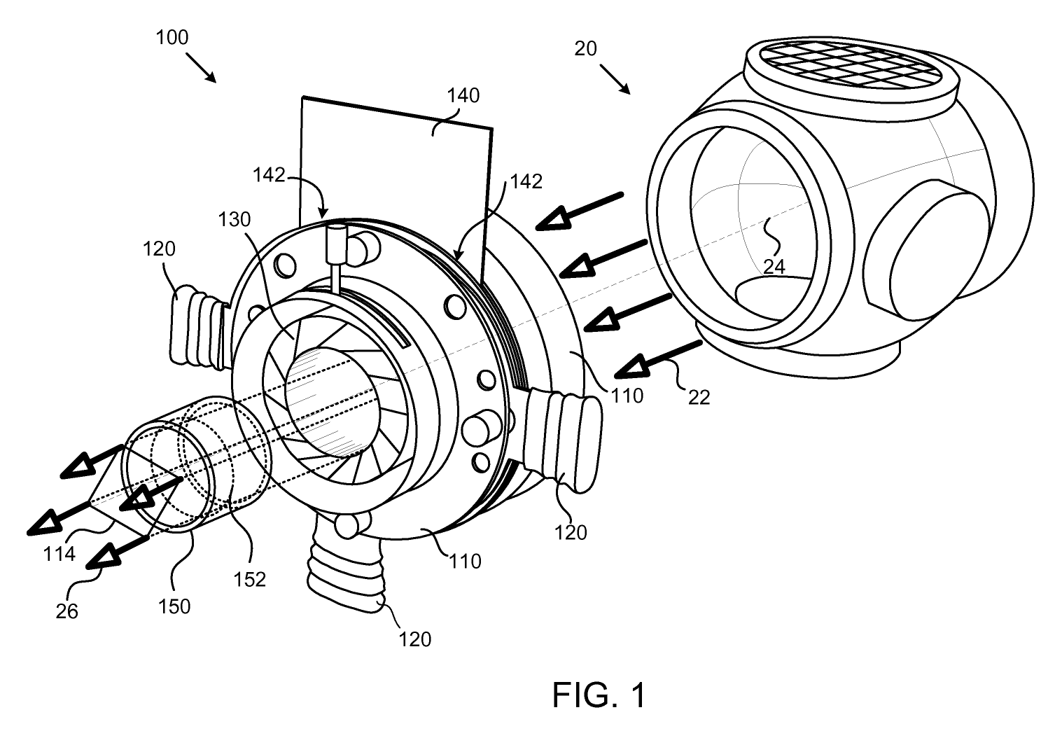

FIG. 1 is a perspective exploded view of an adjustable light shaping apparatus 100 receiving a focused beam of light 22 from a luminaire 20, according to one embodiment. According to the depicted embodiment, the adjustable light shaping apparatus 100 may include a shaping housing 110, one or more adjustable paddles 120, and iris assembly 130, and a template pattern 140 inserted into a slide groove 142. According to one embodiment, the luminaire 20 emits substantially collinear light waves that collectively form a focused beam of light 22. The directionality of the focused beam of light 22 is depicted by the dotted line in FIG. 1, which represents the longitudinal axis 24 of the focused beam of light 22. The focused beam of light 22 is received by the light shaping apparatus 100 and the light shaping apparatus 100 manipulates the light to create a shaped beam of light 26. The shaped beam of light 26 immediately emanating from the adjustable light shaping apparatus 100 has a specific cross-sectional shape 114. This cross-sectional shape 114 is referred to as the ‘source shape’ 114 throughout the pages of this disclosure. This source shape is created by adjusting the adjustable paddles 120, the iris assembly 130, and the template pattern 140.

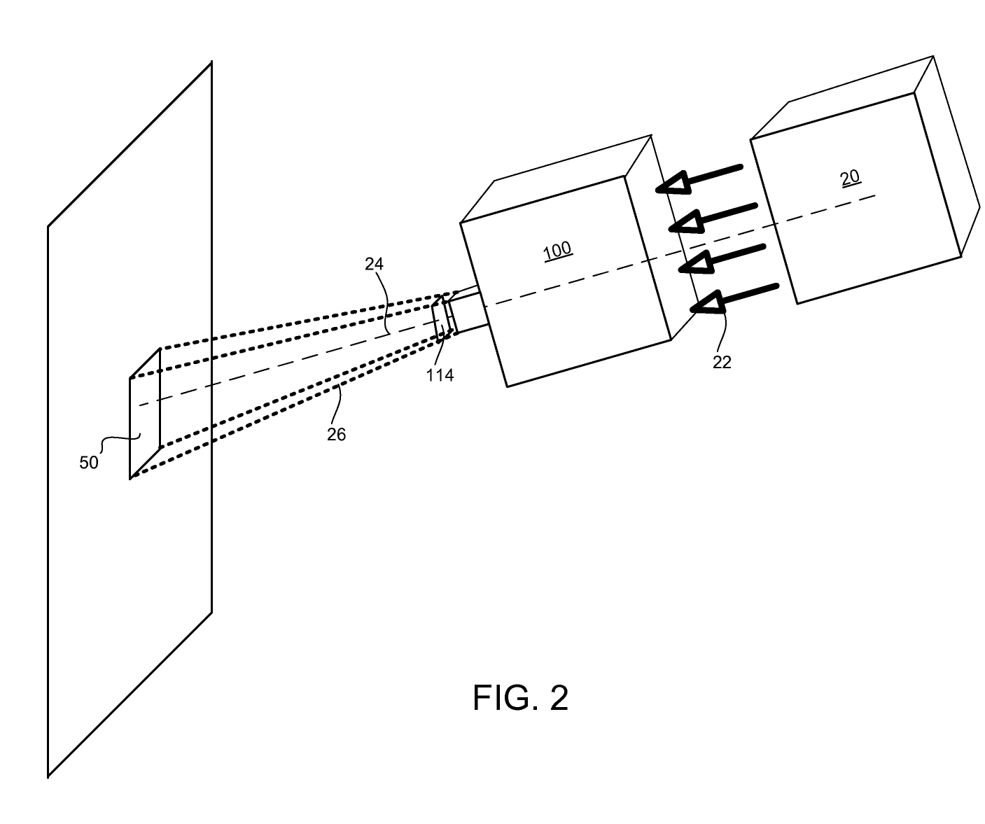

In one embodiment, a focus tube 150 with one or more lenses 152 may be inserted downstream of the adjustable light shaping apparatus 100 and the shaped beam of light 22 is emitted from the focus tube 150. In another embodiment, the luminaire includes the focus tube 150 and the adjustable light shaping apparatus 100 is downstream of focusing performed in the luminaire 20 using the focus tube 150. One of skill in the art will recognize other forms and configurations of a focus tube 150. Note that the focus tube 150 is omitted from FIGS. 2-5 for clarity, but it is understood that the focus tube 150 may be included upstream or downstream of the adjustable light shaping apparatus 100.

The luminaire 20 may be any fixture containing a light source. For example, although the light source is not depicted, the luminaire 20 in FIG. 1 may contain parabolic reflectors configured to reflect light from the light source through an opening in the luminaire 20 housing. This focused beam of light 22, in one embodiment, is substantially focused and does not substantially disperse at a distance. Since FIG. 1 is an exploded view, the luminaire 20 in the depicted embodiment is directly coupled to the adjustable light shaping apparatus 100. However, in some embodiments the luminaire 20 may be removed a distance from the light shaping apparatus 100, the luminaire 20 may be integral with the light shaping apparatus 100, or the luminaire 20 may be removably attached to the light shaping apparatus 100. Specific details regarding the components generally introduced above are included below with reference to FIGS. 2-8.

FIG. 2 is a schematic block diagram of a an adjustable light shaping apparatus 100 receiving a focused beam of light 22 from a luminaire 20 and illuminating a target shape 50, according to one embodiment. As briefly described above, the adjustable light shaping apparatus 100 of the present disclosure is configured to quickly, easily, and adaptably convert a focused beam of light 22 into a shaped beam of light 26 with a specific cross-sectional shape (source shape) 114. The source shape 114 is determined based on the dimensions of the target shape 50 and the distance an angle between the target shape 50 and the light shaping apparatus 100. For example, FIG. 2 shows the light shaping apparatus 100 receiving a focused beam of light 22 from a luminaire 20. Because of the keystone effect, the focused beam of light 22 is shaped by the apparatus 100 so that the source shape 114 is a trapezoid and the shaped beam of light 26 precisely illuminates the rectangular target shape 50. This keystone effect is the distortion caused by projecting light onto a surface at an angle (i.e., the longitudinal axis 24 of the focused beam of light 22 is not orthogonal to the plane of the target shape 50).

Thus, as described below, the light shaping apparatus 100 of the present disclosure is configured to quickly and easily create various source shapes 114 that correlate to various target shapes 50 in various positions without involving the time, expense, and complexity of measuring, calculating, and tediously configuring a conventional luminaire to illuminate a target shape. Some examples of the target shape 50 to be illuminated may include paintings, photographs, logos, sculptures, words, documents, furniture, theatrical sets, and live actors, among others.

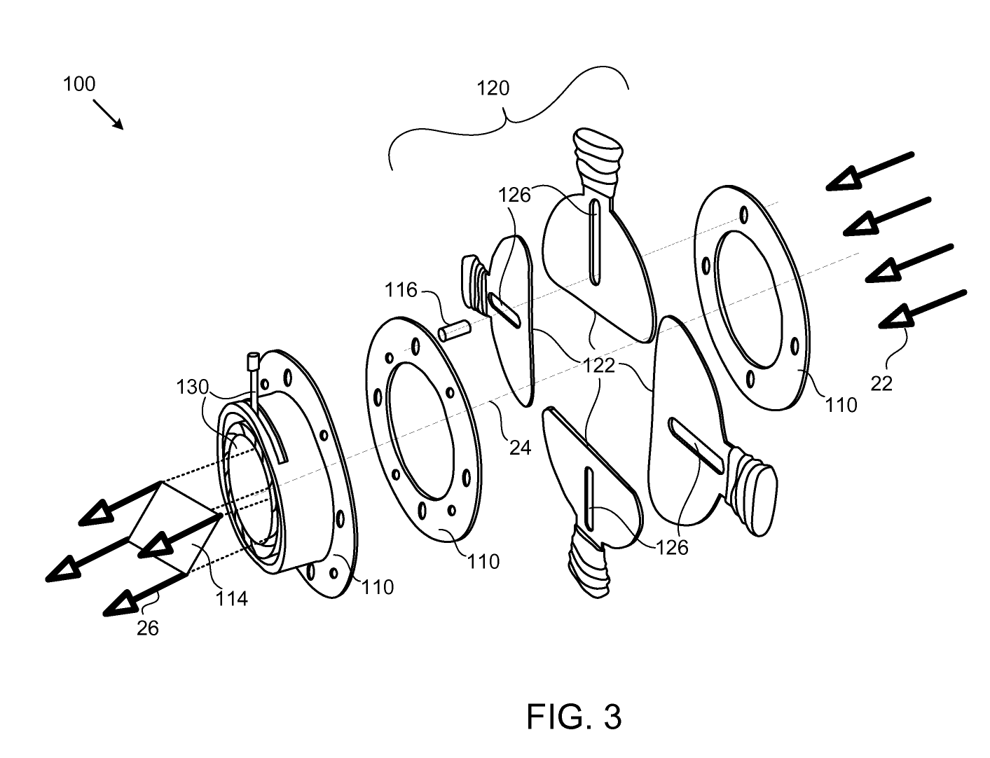

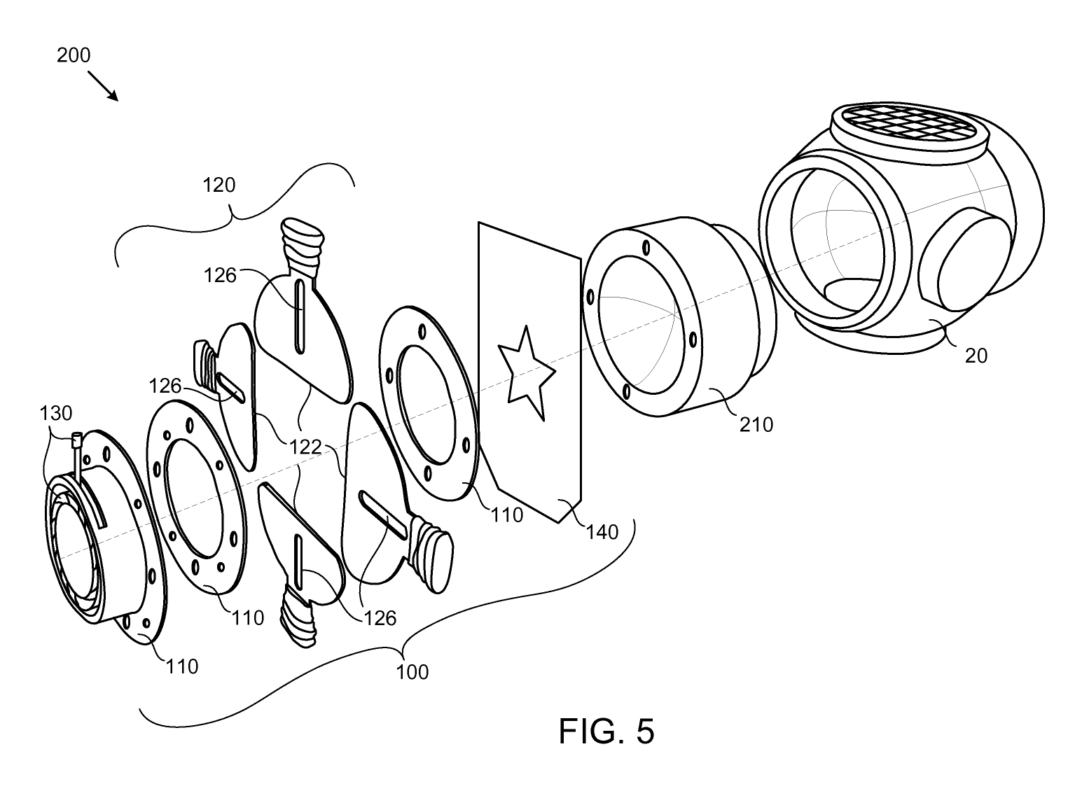

FIG. 3 is a perspective exploded view of an adjustable light shaping apparatus 100, including a shaping housing 110, according to one embodiment. In one embodiment, the shaping housing 110 may be a single, integrated structure (not depicted) for supporting the adjustable paddles 120, the iris assembly 130, and the various other components of the apparatus 100. In another embodiment, as depicted in FIG. 3, the shaping housing 110 may include various flanges, rings, tubes, compartments, and other modular structural components that support the adjustable paddles 120 and the iris assembly 130. For example, the iris assembly 130 may be affixed to the inner diameter of a housing tube that is connectable with a flange or another component. As depicted in FIG. 3, the shaping housing 110 may have multiple ring flanges, between which the adjustable paddles 120 may be supported. As discussed in greater detail below with reference to FIG. 5, the shaping housing 110 may include couplings for attaching light processing components downstream of the apparatus 100 and/or for attaching a luminaire and other light processing components upstream of the apparatus 100.

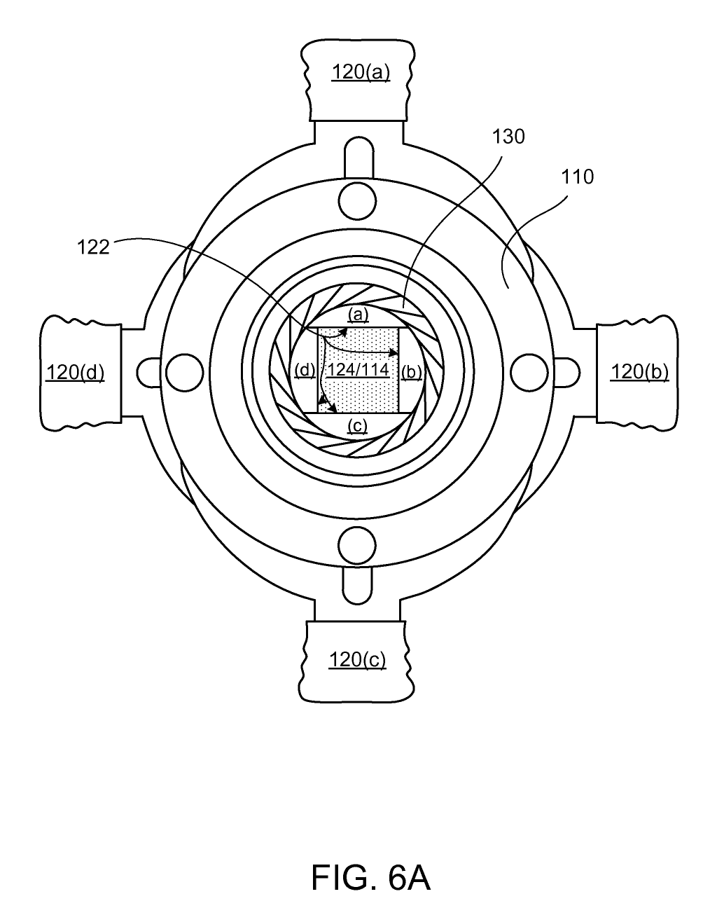

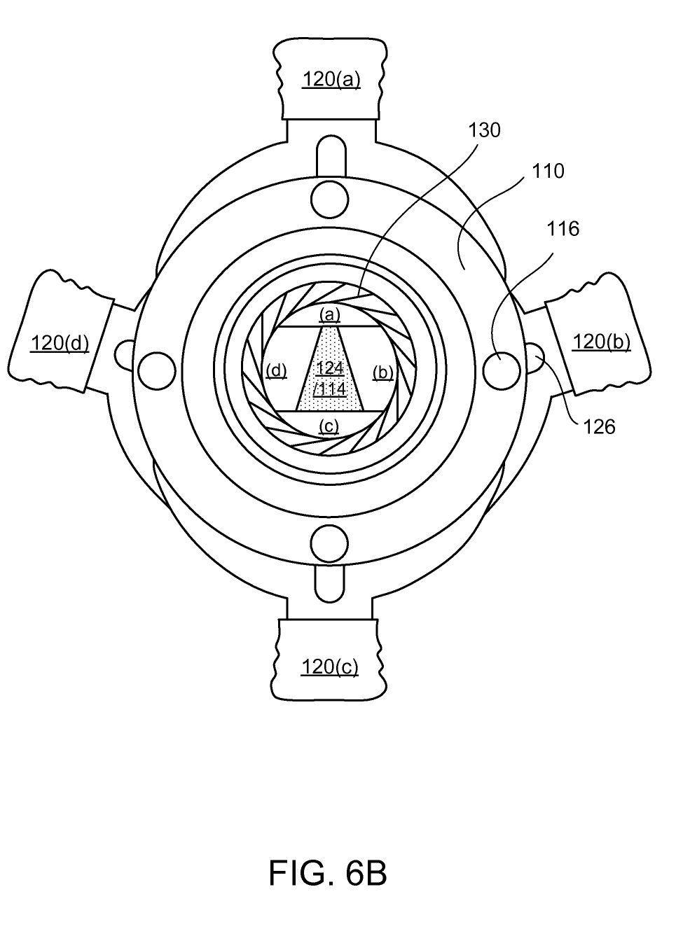

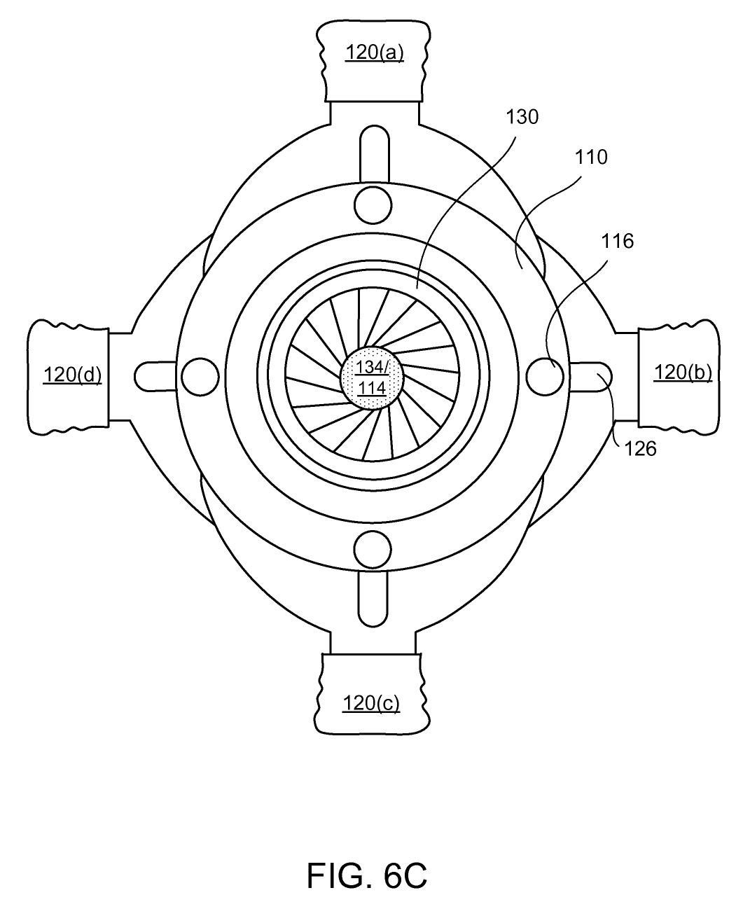

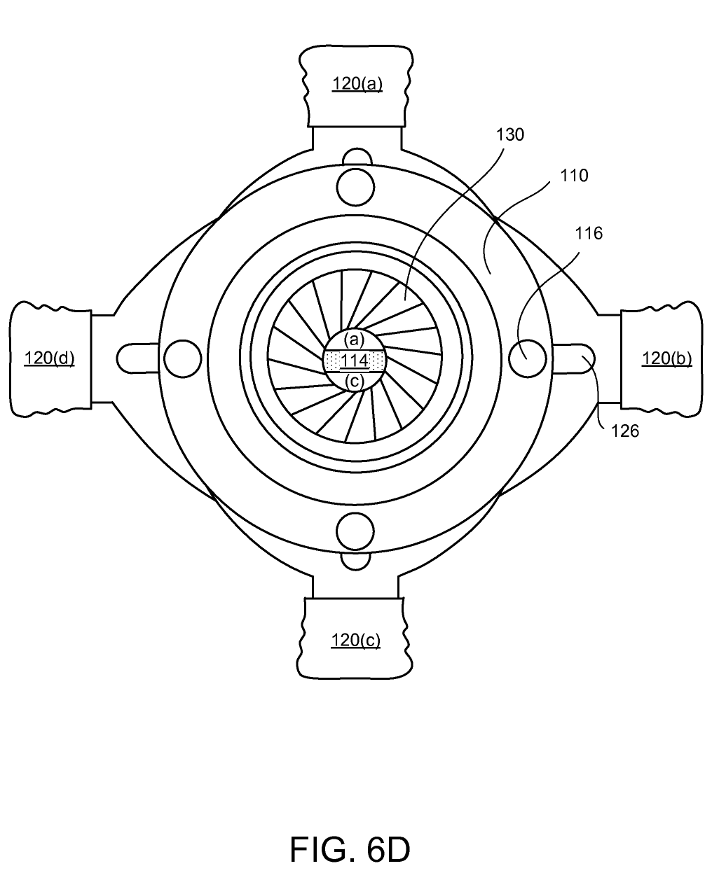

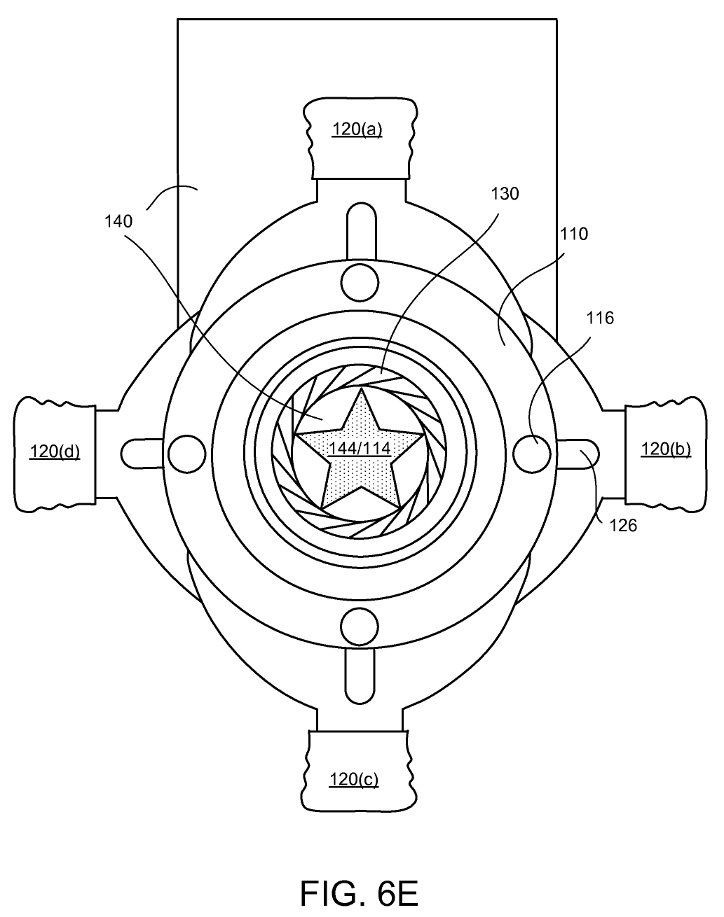

One or more adjustable paddles 120 are movably coupled to the shaping housing 110. Each adjustable paddle 120 has a framing edge 122 that can intersect the focused beam of light 22 to form a partial outline of a paddle-framed shape. Collectively, the adjustable paddles 120 can be configured to frame/outline various shapes. For example, the framing edges 122 may be substantially straight and collectively the paddles 120 may outline a polygonal shape. In another embodiment, the framing edges 122 of the paddles 120 may be substantially curved in order to outline a rounded shape. Further details regarding the paddle-framed shapes that can be created with the adjustable paddles 120 are included below with reference to FIGS. 6A-6E. The adjustable paddles 120 are movably coupled to the shaping housing 110 via a securing assembly 116 (see FIG. 6A for additional details). The adjustable paddles may have elongated slots 126 that engage with the securing assembly 116. In one embodiment, pins or bolts are inserted into the elongated slots 126 and into corresponding holes in the shaping housing 110. In FIG. 3, only a single bolt/pin is depicted to avoid obscuring the Figure. A user may slide the paddles 120 in and out along the length of the elongated slots 126 and may also rotate the paddles about the pins 116. In such an embodiment, the adjustable paddles 120 may be slidable and/or rotatable in a plane that is substantially perpendicular to the longitudinal axis 24 of the focused beam of light 22. The securing assembly 116 may also include a fastening mechanism for securely anchoring, temporarily, the paddles 120 in a certain position. In another embodiment, the securing assembly 116 may be a non-slip layer between the shaping housing 110 and the paddles 120 that prevents the paddles from spontaneously slipping out of a configuration but still allows a user to arrange the paddles 120. In such an embodiment, the paddles 120 would not need to have the elongated slots 126. In another embodiment, two flange members of the shaping housing 110 may surround the paddles 120 and a clamping mechanism may be implemented as the securing assembly 116 to clamp around the flanges and provide pressure, thus preventing the paddles 120 from freely slipping out of their selected positions.

Although the figures show the light shaping apparatus 100 with four adjustable paddles 120, it is contemplated that the light shaping apparatus 100 may have a different number of paddles 120. For example, in one embodiment the light shaping apparatus 100 may be implemented with two paddles 120 that can crop the focused beam of light 22 on two sides. In another embodiment, the apparatus 100 may be implemented with three, five, six, or eight paddles 120 in order to frame a triangle, pentagon, hexagon, or an octagon, accordingly. Also, the depicted paddles 120 include handles for manual manipulation. In other words, the paddles 120 may be manually adjusted by a user to create the desired paddle-framed shape. However, in another embodiment, the paddles 120 may be automated and may be mechanically adjusted through the use of force actuators. Also, the paddles 120 may move independently or may be inter-coupled in such a way that their movement is dependent on the others. In yet another embodiment, the paddles 120 may be configured to have certain presets or pre-determined positions that enable a user to rapidly toggle the paddles into default, pre-selected patterns.

The light shaping apparatus 100 also includes an iris assembly 130. The iris assembly 130 includes an iris that is expandable and collapsible to create openings with varying diameters. Thus, a user may cause the iris assembly 130 to dilate to create a large opening for light to pass through or the user may cause the iris assembly 130 to collapse so that only a small opening is available for light to pass through. The shape formed by the iris assembly is the iris-framed shape. The iris-framed shape may be combined with the paddle-framed shape to generate a hybrid polygonal/circular source shape 114 (hybrid shape not depicted in FIG. 3, see FIGS. 6A-6E for examples of source shape). In another embodiment, not depicted, the iris assembly may be rectangular iris or a triangular iris. In such embodiments, the iris assembly 130 can be used to vary the diameter/width of the respective shapes. As depicted in the figures, the iris assembly 130 may include a lever for manual actuation.

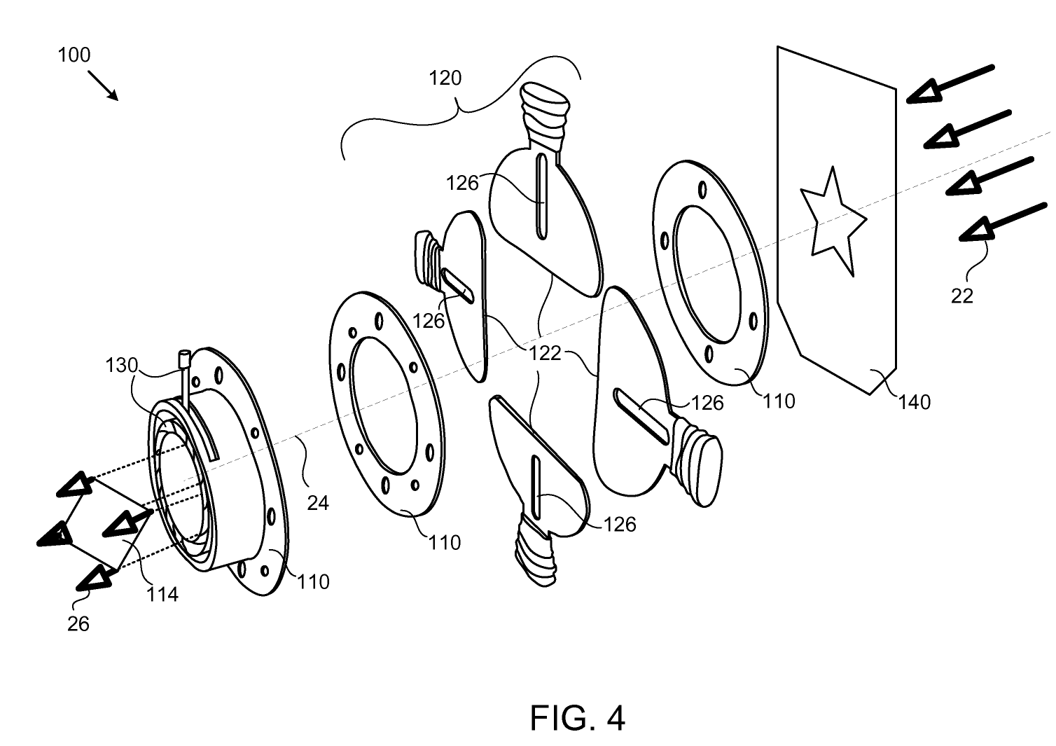

As briefly described above, the paddles 120 and the iris assembly 130 may be manually adjusted. In another embodiment, the paddles 120 and/or the iris assembly 130 may be automated or mechanically actuated. For example, the movement of the paddles 120 and the iris assembly 130 may be controlled by a computer program via a user interface mounted on the shaping housing 110. In another embodiment, the paddles 120 and the iris assembly 130 may be programmed to change the source shape 114 in order to track movement or changes in the target shape 50. Additionally, the depicted order of the components (i.e., the paddles 120 upstream from the iris assembly 130) is not to be construed as a limitation of the scope of the present disclosure. In other words, the iris assembly 130 may be upstream from the paddles 120. Further, in certain embodiments when a template pattern 140 is implemented, the depicted order of the components 120, 130, 140 (see FIG. 4) is also not limiting of the scope of the present disclosure. Also, the exact shapes, relative sizes, and appearances of the shaping housing 110, the paddles 120, the iris assembly 130, and the template pattern 140 are not limited to the embodiments depicted in the figures. In other words it is contemplated that one of ordinary skill in the art will recognize other configurations of the components that fall within the scope of the present disclosure.

FIG. 4 is a perspective exploded view of an adjustable light shaping apparatus 100, according to another embodiment. In the depicted embodiment, the light shaping apparatus 100 also includes a template pattern 140. The template pattern 140 may have a specific shape cutout (“template-framed shape”) that allows the light shaping apparatus 100 to illuminate specific custom shapes. For example, a template pattern 140 may have a specific template-framed shape that corresponds to a specific logo or a specific trademark that a user wishes illuminate. The template pattern 140 may be inserted into a slide groove 142 (see FIG. 1). The slide groove 142 may not actually be a groove but may instead be a slot or a space between two shaping housing 110 members that allows for a template pattern 140 to be inserted to intersect the focused beam of light 22. In another embodiment, the slide groove 142 may be a pin or a surface between two shaping housing 110 components upon which or against which the template pattern 140 rests. In the depicted embodiment, the template pattern 140 and the corresponding template-framed shape may be implemented in conjunction with the paddles 120 and the iris assembly 130 to modify and alter the specific custom template-framed shape. Additional details relating to the template framed-shape are included below with reference to FIGS. 6A-6E.

FIG. 5 is a perspective exploded view of an adjustable light shaping system 200, including an adjustable light shaping apparatus 100, a light condensing assembly 210, and a luminaire 20, according to one embodiment. The light condensing assembly 210 may have one or more lenses that condense light from the light source to the focused beam of light 22. In addition to, or in place of, the condensing assembly 210, the system 200 may include other focusing, stabilizing, or other light processing components, according to the specifics of a given application. For example, the light condensing assembly 210 may include a series of glass or acrylic convex and/or bi-convex optically engineered lenses with ground focal points. These lenses may be used to condense, focus, or otherwise process the focused beam of light 22 and may be attachable to the shaping housing 110 using clamps, fasteners, bolts, adhesives, etc. For example, in one embodiment a focus tube may be attached (downstream) to the shaping housing 110 to produce a sharp and focused illumination of the target shape 50. The focus tube may have objective lenses that further determine the shape of the focused beam of light 22. In another embodiment, the length of the focus tube may be manually or automatically adjusted (telescoping) to further process and shape the focused beam of light 22.

As described above the luminaire 20 may be any fixture containing a light source. For example, although the light source is not depicted, the luminaire 20 in FIG. 5 may contain parabolic reflectors configured to collect and reflect light from the light source through an opening in the luminaire 20 housing. This focused beam of light 22, in one embodiment, is substantially focused and does not substantially disperse at a distance. Since FIG. 5 is an exploded view, the luminaire 20 in the depicted embodiment is directly coupled to the adjustable light condensing assembly 210. However, in some embodiments the luminaire 20 may be removed a distance from the light condensing assembly 210, the luminaire 20 may be integral with the light condensing assembly 210, or the luminaire 20 may be removably attachable to the light condensing assembly 210. The luminaire 20 may include an electrical interface for powering the light source and may also include a mesh window, heating transfer fins, a fan, or other temperature control mechanisms for maintaining the temperature of the luminaire below a certain temperature.

Although not depicted, the shaping housing 110 of the light shaping apparatus 100 may include housing couplings that enable the apparatus 100 to be connected to the luminaire and/or to other components, such as the light condensing assembly 210. The shaping housing may also be adaptable to a plurality of shaping housing couplings and each shaping housing coupling may be configured for a specific luminaire 20. In another embodiment, the housing coupling is adaptable to two or more luminaires 20, wherein each of the two or more luminaires has a different interface for coupling. In yet another embodiment, the shaping housing 110 is integral with the luminaire 20. In other words, the light shaping apparatus 100 may be retrofitted to connect with an existing luminaire 20. For example, the shaping housing 110 may have housing couplings, such as clamps, fasteners, clips, bolts, adhesive layers, etc., that facilitate attaching the light shaping apparatus 100 to an existing luminaire. Different housing coupling mechanisms may be included with the light shaping apparatus 100 to enable the apparatus 100 to be connected with different luminaires made by different manufacturers.

FIG. 6A is a cross-sectional front view of an adjustable light shaping apparatus 100 depicting a rectangular, paddle-framed 124 source shape 114, according to one embodiment. As described above, the adjustable paddles 120 may be positioned so that the framing edges 122 collectively outline a paddle-framed shape, such as the rectangle depicted in FIG. 6A. The four paddles depicted in FIG. 6A are labeled 120(a), 120(b), 120(c), and 120(d). The same corresponding letters are also depicted near the paddle-framed shape to delineate the framing edges 122 of the respective paddles. In the depicted embodiment, the iris assembly 130 is shown, but since the iris is dilated so as to have a diameter that is greater than the width of the paddle-framed shape 124, thus the iris does not contribute to the source shape 114 in the depicted embodiment.

FIG. 6B is a cross-sectional front view of an adjustable light shaping apparatus 100 depicting a trapezoidal, paddle-framed 124 source shape 114, according to one embodiment. As described above, the adjustable paddles 120 may be positioned so that the framing edges 122 collectively outline a paddle-framed shape, such as the trapezoid depicted in FIG. 6A. The four paddles depicted in FIG. 6A are labeled 120(a), 120(b), 120(c), and 120(d). The same corresponding letters are also depicted near the paddle-framed shape to delineate the framing edges 122 of the respective paddles. As depicted, paddles 120(b) and 120(d) have been tilted to create the sloped sides of the trapezoid 124, 114. In the depicted embodiment, the iris assembly 130 is shown, but since the iris is dilated so as to have a diameter that is greater than the width of the paddle-framed shape 124, thus the iris does not contribute to the source shape 114 in the depicted embodiment. As previously described, the apparatus 100 may not have four paddles according to the specifics of a given application. For example, the apparatus 100 may have eight paddles 120 to allow a user to frame an octagon shape.

FIG. 6C is a cross-sectional front view of an adjustable light shaping apparatus 100 depicting a circular, iris-framed 134 source shape 114, according to one embodiment. In the depicted embodiment, the iris has been collapsed so that only a small circular iris framed shape 134 is present. The paddles 120 may be retracted to a certain degree from the shaping housing 110 to prevent the framing edges 122 of the paddles from intersecting the focused beam of light 22 and contributing to the source shape 114.

FIG. 6D is a cross-sectional front view of an adjustable light shaping apparatus 100 depicting a rectangular-circular hybrid source shape 114, according to one embodiment. In the depicted embodiment, both the paddles 120 and the iris assembly 130 may contribute to the source shape 114. As depicted, paddles 120(a) and 120(c) are contributing the top and bottom lines of the source shape 114 while the other paddles, 120(b) and 120(d), are retracted from the shaping housing 110 to as to not contribute to the source shape 114. The iris assembly 130 is collapsed down in order to contribute the curved sides of the source shape 114. By combining the paddles 120 with the iris assembly 130, various polygon and curved source shapes 114 may be generated.

FIG. 6E is a cross-sectional front view of an adjustable light shaping apparatus 100 depicting a template-framed 144 source shape 114, according to one embodiment. In the depicted embodiment, a template pattern 140 has been inserted into a slide groove of the shaping housing 110. The template pattern 140 has a star shaped cutout that forms the template-framed shape 144. The paddles 120 have been retracted from the shaping housing 110 and the iris assembly 130 has been expanded to so as to not contribute to the source shape 114. In another embodiment, not depicted, paddles 120(c) may be reinserted into the shaping housing 110 to intersect the focused beam of light 22 and contribute to the source shape 114 by cutting off the bottom portion of the start shape.

As described above, the template pattern 140 may have a custom shape. In another embodiment, the template pattern 140 may include a transparent colored film across the cutout to provide different colors or color hues to the target shape. In another embodiment, the apparatus 100 may also include multiple slide grooves 142 so that multiple template patterns 140 may be used, thus allowing the source shape 114 to be made from the stacking of multiple template patterns.

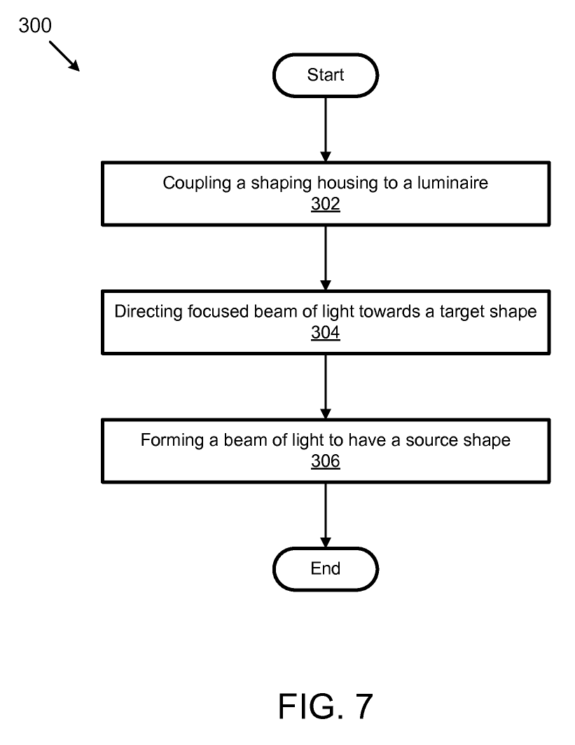

FIG. 7 is a schematic flow chart diagram depicting a method 300 for illuminating a target shape 50, according to one embodiment. The method 300 includes coupling 302 a shaping housing 110 to a luminaire 20 so that the shaping housing 110 can receive a focused beam of light 22 from the luminaire 20. The method 300 further includes directing 304 the focused beam of light 22 towards a target shape 50 and then forming 306 a shaped beam of light 26 to have a source shape 114 that emerges from the shaping housing 110.

The method may further involve a shaping housing that has a slide groove for receiving a template pattern, the template pattern shaped to outline a template-framed shape. Therefore, forming a source shape includes one or more of the following: adjusting the adjustable paddles so that the framing edges outline a paddle-framed shape, adjusting the iris assembly to outline an iris-framed shape, and inserting a template pattern to outline a template-framed. Adjusting the paddles may include rotating the adjustable paddles in a plane that is substantially perpendicular to the longitudinal axis of the focused beam of light 22 and/or sliding the adjustable paddles in a plane that is substantially perpendicular to the longitudinal axis of the focused beam of light 22. Still further, adjusting the paddles may include loosening a securing assembly in order to move adjustable paddles with respect to the shaping housing and subsequently re-tightening the securing assembly when the adjustable paddles are in a desired position.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An adjustable light shaping apparatus comprising:
a shaping housing that receives a focused beam of light from a luminaire and outlines a source shape through which the focused beam of light emanates to illuminate a target shape;
two or more adjustable paddles movably coupled to the shaping housing, wherein each of the adjustable paddles is independently adjustable and each adjustable paddle has a framing edge, wherein the adjustable paddles may be oriented so that the framing edges intersect the focused beam of light and collectively illuminate an outline of a paddle-framed shape; and
an iris assembly connected to the shaping housing, the iris assembly comprising an expandable and contractible iris that may intersect the focused beam of light to illuminate an outline of an iris-framed shape;
wherein the source shape comprises one of the paddle-framed shape, the iris-framed shape, and a combination of the paddle-framed shape and the iris-framed shape.

2. The adjustable light shaping apparatus of claim 1, further comprising a slide groove in the shaping housing configured to receive a template pattern, wherein when the template pattern is inserted into the slide groove the template pattern intersects the focused beam of light to outline a template-framed shape, wherein the source shape comprises one of the paddle-framed shape, the iris-framed shape, the template-framed shape, and a combination of one or more of the paddle-framed shape, the iris-framed shape, and the template-framed shape.

3. The adjustable light shaping apparatus of claim 1, wherein the target shape is a rectangle and the adjustable light shaping apparatus is positioned off center of the target shape and the source shape, comprising the paddle-framed shape, is a trapezoid to illuminate the rectangular target shape.

4. The adjustable light shaping apparatus of claim 1, wherein the source shape is a polygonal-circular hybrid shape comprising portions of the paddle-framed shape and the iris-framed shape.

5. The adjustable light shaping apparatus of claim 1, wherein the adjustable paddles are one or more of:
rotatable in a plane that is substantially perpendicular to the longitudinal axis of the focused beam of light; and
slidable in a plane that is substantially perpendicular to the longitudinal axis of the focused beam of light.

6. The adjustable light shaping apparatus of claim 1, wherein each of the adjustable paddles comprises an elongated slot that engages a securing assembly configured to hold the adjustable paddles in place with respect to the shaping housing.

7. The adjustable light shaping apparatus of claim 6, wherein the securing assembly comprises a bolt assembly for securing the position of the adjustable paddles.

8. The adjustable light shaping apparatus of claim 1, wherein the framing edges of the adjustable paddles are substantially straight to outline a polygonal paddle-framed shape.

9. The adjustable light shaping apparatus of claim 1, wherein the framing edges of the adjustable paddles are substantially curved to outline a rounded paddle-framed shape.

10. The adjustable light shaping apparatus of claim 1, further comprising a shaping housing coupling that connects the shaping housing to the luminaire.

11. The adjustable light shaping apparatus of claim 10, wherein the shaping housing is adaptable to a plurality of shaping housing couplings, each shaping housing coupling configured for a specific luminaire.

12. The adjustable light shaping apparatus of claim 10, wherein the housing coupling is adaptable to two or more luminaires, wherein each of the two or more luminaires has a different interface for coupling.

13. The adjustable light shaping apparatus of claim 1, wherein the shaping housing is integral with the luminaire.

14. The adjustable light shaping apparatus of claim 1, wherein the luminaire comprises a framing projector, the framing projector comprising a light condensing assembly, the light condensing assembly comprising one or more lenses that condense light from the light source to the focused beam of light.

15. The adjustable light shaping apparatus of claim 1, wherein the luminaire comprises a theatrical spot light, the theatrical spot light configured to produce the focused beam of light to transmit to the shaping housing.

16. A method for illuminating a target shape, the method comprising:
coupling a shaping housing to a luminaire, the shaping housing receiving a focused beam of light from the luminaire, the shaping housing comprising
two or more adjustable paddles movably coupled to the shaping housing, wherein each of the adjustable paddles is independently adjustable and each adjustable paddle has a framing edge, and
an iris assembly connected to the shaping housing, the iris assembly comprising an expandable and contractible iris;
directing the focused beam of light towards a target shape; and
forming a beam of light to have a source shape that emerges from the shaping housing, wherein forming a source shape comprises adjusting one or more of
the adjustable paddles so that the framing edges outline a paddle-framed shape, and
the iris assembly to outline an iris-framed shape.

17. The method of claim 16, wherein the shaping housing further comprises a slide groove that receives a template pattern, the template pattern shaped to outline a template-framed shape, wherein forming a source shape comprises one or more of
adjusting the adjustable paddles so that the framing edges outline a paddle-framed shape;
adjusting the iris assembly to outline an iris-framed shape; and
inserting a template pattern to outline a template-framed shape

18. The method of claim 16, wherein adjusting the adjustable paddles comprises one or more of
rotating the adjustable paddles in a plane that is substantially perpendicular to the longitudinal axis of the focused beam of light; and
sliding the adjustable paddles in a plane that is substantially perpendicular to the longitudinal axis of the focused beam of light.

19. The method of claim 16, wherein adjusting the adjustable paddles comprises loosening a securing assembly in order to move adjustable paddles with respect to the shaping housing and subsequently re-tightening the securing assembly when the adjustable paddles are in a desired position.

20. An adjustable framing projector system comprising:
a light source mounted within a luminaire, wherein the light source within the luminaire generates a focused beam of light;
a light condensing assembly mounted within the luminaire or attached to the luminaire, wherein the light condensing assembly receives light from the light source and focuses the light to form the focused beam of light;
a shaping housing that receives the focused beam of light from the light condensing assembly and shapes the focused beam of light to form a source shape through which the focused beam of light emanates to illuminate a target shape;
two or more adjustable paddles movably coupled to the shaping housing, wherein each of the adjustable paddles is independently adjustable and each adjustable paddle has a framing edge, wherein the adjustable paddles may be oriented so that the framing edges intersect the focused beam of light and collectively outline a paddle-framed shape;
an iris assembly connected to the shaping housing, the iris assembly comprising an expandable and contractible iris to intersect the focused beam of light to outline an iris-framed shape; and
a slide groove in the shaping housing configured to receive a template pattern, wherein when the template pattern is inserted into the slide groove the template pattern intersects the focused beam of light to illuminate a template-framed shape;
wherein the source shape comprises one or more of the paddle-framed shape, the iris-framed shape, the template-framed shape, and a combination of one or more of the paddle-framed shape, the iris-framed shape, and the template-framed shape.
